(19) United States
(12) Patent Application Publication
(10) Pub. No.: US 2012/0315595 A1
(43) Pub. Date: Dec. 13, 2012

(54) BRACKET WITH FRONT OPENING AND ORTHODONTIC INTER-BRACKET ADJOINING MECHANISM

(76) Inventor: Jean Beaudoin, Levis (CA)

(21) Appl. No.: 13/579,383

(22) PCT Filed: Feb. 25, 2011
(86) PCT No.: PCT/CA2011/000218

§ 371 Date: Aug. 16, 2012

Related U.S. Application Data
(60) Provisional application No. 61/308,226, filed on Feb. 25, 2010.

(51) Int. Cl. A61C 7/28; B23P 17/00; A61C 7/16

(52) U.S. Cl. 433/9; 433/24; 29/896.11

(57) ABSTRACT

An orthodontic bracket for an orthodontic system has a rear base for being mounted to a tooth and first and second portions extending from the rear base. The first and second portions are spaced apart to provide a slot for positioning an arch wire therein. The first and second portions define a front face with an opening for receiving the arch wire. At least one of the first and second portions includes an adjustable tightening element for adjusting the pressure on the arch wire. An orthodontic bracket system comprises a plurality of brackets for being mounted to the teeth of a patient and at least one inter-bracket adjoining assembly mounted to a pair of adjacent brackets and interposed therebetween. The length of said inter-bracket adjoining assembly is modifiable so as to correspondingly modify the distance between the pair of adjacent brackets.

### CROSS-REFERENCE TO RELATED APPLICATIONS

This application claims priority on U.S. Provisional Patent Application Ser. No. 60/308,226 filed on Feb. 25, 2010 and incorporated by reference herein in its entirety.

### TECHNICAL FIELD

The present disclosure relates to orthodontic brackets. More specifically but not exclusively, a bracket with front opening and orthodontic bracket system with inter-bracket adjoining mechanism.

### BACKGROUND

Orthodontic brackets and systems such are devices used in the orthodontic industry in order to align and straighten teeth and help to position them with regard to the bite of the patient. They are often used to correct under bites, as well as, malocclusions, overbites, cross bites, open bites, deep bites, crooked teeth, and various other flaws of the teeth and jaw. These systems include brackets each having a base secured to the face of a tooth and an arch wire mounted to these brackets for adding pressure thereto. The arch wire can be anchored to a tooth via a set screw which is periodically adjusted for greater tension or lesser tension to be applied to this wire.

Teeth are caused to move when the arch wire puts pressure on the brackets and thereby the teeth. When this occurs, the periodontal membrane stretches on one side and is compressed on the other thereby loosening the tooth and then new bone grows in to support the tooth in its new position This movement is done slowly so as not to completely disconnect the tooth from the jaw and as such orthodontic treatments are performed over a long period with periodic adjustments. A tooth will usually move about a millimeter per month during orthodontic movement, but there is high individual variability. Orthodontic mechanics can vary in efficiency, and hence, there is wide range of response to orthodontic treatment.

There thus remains a need for improved brackets and orthodontic systems to provide more efficient treatments.

### OBJECTS OF THE DISCLOSURE

An object of the present disclosure is to provide an orthodontic bracket.

An object of the present disclosure is to provide an orthodontic bracket system.

### SUMMARY OF THE DISCLOSURE

Aspects of the disclosure will now be disclosed hereunder.

In accordance with aspect of the present disclosure there is provided an orthodontic bracket for an orthodontic system comprising:

a rear base for being mounted to a tooth; and

first and second portions extending from the rear base and being spaced apart thereby providing a slot therebetween for positioning an arch wire therein and defining a front opening for receiving the arch wire into the slot, at least one of the first and second portions comprising an adjustable tightening element for engaging the arch wire,

wherein adjustment of the tightening element provides for increasing or decreasing tension against the arch wire within the slot.

In accordance with aspect of the present disclosure there is provided an orthodontic bracket for an orthodontic system comprising:

a rear base defining a rear face for being mounted to a tooth; and

first and second portions extending from the rear base and providing a slot therebetween for positioning an arch wire therein and defining a front face having at least one opening being contiguous with a rear opening formed in the rear face,

wherein injecting an adhesive substance within the one opening provides for applying the adhesive substance between the rear base and the tooth via said rear opening.

In embodiment, the first and second portions are spaced apart thereby providing said slot therebetween. In an embodiment, the front face further comprises a front opening for receiving the arch wire into the slot.

In accordance with aspect of the present disclosure there is provided an orthodontic bracket for an orthodontic system comprising:

a rear base for being mounted to a tooth; and

first and second portions extending from the rear base and being spaced apart thereby providing a slot therebetween for positioning an arch wire therein and defining a front opening for receiving the arch wire into the slot.

In an embodiment, the bracket further comprises lateral sides comprising openings being contiguous with the slot thereby providing for the arch wire to extend therethrough. In an embodiment, an insert is mountable to a lateral side opening for decreasing the width thereof.

In accordance with aspect of the present disclosure there is provided an orthodontic bracket system comprising:

a plurality of brackets for being mounted to the teeth of a patient; and

at least one inter-bracket adjoining assembly mounted to a pair of adjacent brackets and interposed therebetween,

wherein the length of said inter-bracket adjoining assembly is modifiable so as to correspondingly modify the distance between the pair of adjacent brackets.

In an embodiment, the inter-bracket adjoining assembly comprises a pair of separate adjoining elements. In an embodiment, each separate adjoining element comprises a respective mounting element for being mounted to one of the pair of brackets. In an embodiment, the bracket comprises lateral sides configured to receive a the mounting element. In an embodiment, movement of one of the mounting members mounted to the bracket provides for modifying the length of the inter-bracket adjoining assembly. In an embodiment, the inter-bracket adjoining assembly comprises a pair of coils, each coil being secured to a respective one of said pair of adjacent brackets. In an embodiment, the coils are intertwined. In embodiment, movement of one coil in a first direction provides for moving it into the other coild thereby decreasing the length of the inter-bracket adjoining assembly, wherein movement of the coil in a second direction provides for moving it outwardly of the other coil thereby increasing the length of the inter-bracket adjoining assembly.

In accordance with aspect of the present disclosure there is provided an orthodontic bracket system comprising:

a plurality of brackets for being mounted to the teeth of a patient; and

at least one inter-bracket adjoining assembly comprising a flexible and resilient element and being mounted to a pair of adjacent brackets and interposed therebetween,

wherein the resilient element is so compressible or extendable as to correspondingly modify the distance between said pair of adjacent brackets.

In an embodiment, the flexible and resilient member comprises a coil being secured to a respective one of the pair of adjacent brackets. In an embodiment, movement of the coil in a first direction compresses it providing a compression and movement of the coil in a second direction provides for extending the coil.

In accordance with aspect of the present disclosure there is provided an orthodontic bracket system comprising:

a rear base for being mounted to a tooth;

first and second portions extending from the rear base and being spaced apart thereby providing a slot therebetween and defining a front opening leading to the slot; and

an arch wire comprising indented portions thereof for being positioned within the slot via the front opening.

In an embodiment, the arch wire comprises outward portions alternating with the indented portions along the length thereof, the outward portions being provided to follow the dental arcade when mounted to the teeth of the user. In an embodiment, the bracket further comprises lateral sides comprising openings for providing the arch wire to extend therefrom. In an embodiment, at least one insert is provided for being inserted in a given said bracket thereby decreasing the width of said lateral side opening.

In accordance with an aspect of the present disclosure, there is provided a kit comprising any one of the brackets disclosed herein.

In accordance with an aspect of the present disclosure, there is provided a kit comprising any one of the orthodontic bracket assemblies disclosed herein.

In accordance with an aspect of the present disclosure, there is provided a method of treating the dental bite of a human patient by applying to the teeth of the human patient any of the orthodontic bracket systems disclosed herein. Other objects, advantages and features of the present disclosure will become more apparent upon reading of the following non-restrictive description of non-limiting illustrative embodiments thereof, given by way of example only with reference to the accompanying drawings.

### BRIEF DESCRIPTION OF THE DRAWINGS

In the appended drawings, where like reference numerals denote like elements throughout and in where:

FIG. 1 is a left top perspective view of an orthodontic bracket in accordance with a non-restrictive illustrative embodiment of the present disclosure;

FIG. 1A is an enlarged version of FIG. 1;

FIG. 2 is a right perspective view of the orthodontic bracket of FIG. 1;

FIG. 2A is an enlarged view of FIG. 2;

FIG. 3 is lateral side view of the orthodontic bracket of FIG. 1;

FIG. 4 is a front elevational view of the orthodontic bracket of FIG. 1;

FIG. 5 is a right perspective view of the orthodontic bracket of FIG. 1 mounted to a pair of coils of an inter-bracket adjoining system in accordance with a non-restrictive illustrative embodiment of the present disclosure;

FIG. 5A is a front view of the set screw of orthodontic bracket of FIG. 1;

FIG. 6 is a rear perspective view of immobile coil of the inter-bracket adjoining assembly of FIG. 5;

FIG. 7 is a rear perspective view of mobile coil of the inter-bracket adjoining assembly of FIG. 5;

FIG. 8 is a front elevational view of a pair of adjoined brackets orthodontic brackets of FIG. 1 with the inter-bracket adjoining assembly of FIG. 5 defining an orthodontic bracket system;

FIG. 8A is a front elevational view of an orthodontic bracket system in accordance with another non-restrictive illustrative embodiment of the present disclosure;

FIG. 9 is a left top perspective view of the orthodontic bracket of FIG. 1 with a locking insert in accordance with a non-restrictive illustrative embodiment of the present disclosure;

FIG. 10 is a right perspective view of an orthodontic bracket system including orthodontic brackets and an orthodontic inter-bracket adjoining assembly mounted to the teeth of a subject in accordance with another non-restrictive illustrative embodiment of the present disclosure;

FIG. 11 is a front perspective view of the orthodontic bracket system of FIG. 10;

FIGS. 12, 14, 15 and 16 are respective lateral views of an orthodontic bracket in accordance with non-restrictive illustrative embodiments of the present disclosure being mounted to a tooth;

FIG. 13 is a right perspective view of an orthodontic bracket system including a plurality of the brackets of FIG. 12 mounted to teeth and a bracket adjoining mechanism in accordance with yet a further non-restrictive illustrative embodiment of the present disclosure;

FIG. 17 is a top perspective view of an orthodontic bracket system including a plurality of the brackets with an arch wire mounted thereto in accordance with still a further non-restrictive illustrative embodiment of the present disclosure;

FIG. 17A is an is an enlarge view of a portion of FIG. 17;

FIG. 18 is a sectional view taken along line A-A of FIG. 17;

FIG. 19 is a sectional view taken along line B-B of FIG. 17;

FIG. 20 is a top plan view of the arch wire of the orthodontic bracket system of FIG. 17 thereto in accordance with a non-restrictive illustrative embodiment of the present disclosure;

FIGS. 21 and 22 are respective top and bottom perspective views of a bracket insert for the brackets of the orthodontic bracket system of FIG. 17 accordance with a non-restrictive illustrative embodiment of the present disclosure;

FIG. 23 is a front perspective view of an orthodontic bracket in accordance with another non-restrictive illustrative embodiment of the present disclosure;

FIG. 24 is a rear perspective view of the orthodontic bracket of FIG. 23;

FIG. 25 is a top plan view of the orthodontic bracket of FIG. 23; and

FIG. 26 is a left perspective view of an orthodontic bracket system including orthodontic brackets and an orthodontic inter-bracket adjoining assembly mounted to the teeth of a subject in accordance with still another non-restrictive illustrative embodiment of the present disclosure.

### DETAILED DESCRIPTION OF ILLUSTRATIVE EMBODIMENTS

Generally stated, in a non-exclusive embodiment thereof, the present disclosure provides an orthodontic bracket for an orthodontic system comprising a rear base for being mounted to a tooth and first and second portions extending from the rear base and being spaced apart thereby providing a slot therebetween and defining a front opening. The slot provides for positioning an arch wire therein and the front opening provides for receiving the arch wire into the slot.

In one embodiment, at least one of the first and second portions comprises an adjustable tightening element for engaging the arch wire. Adjustment of the tightening element provides for increasing or decreasing tension against the arch wire within the slot.

In another embodiment, the bracket lateral sides are open to allow the arch wire to extend therethrough and insert can decrease the width of the lateral side openings.

Generally stated, in a non-exclusive embodiment thereof, the present disclosure provides an orthodontic bracket for dental braces comprising a rear base defining a rear face for being mounted to a tooth with first and second portions extending therefrom. The first and second portion provide a slot therebetween for positioning an arch wire therein and define a front face having at least one opening being contiguous with a rear opening formed in the rear face. Injecting an adhesive substance within the at least one opening provides for applying the adhesive substance between the rear base and the tooth via the rear opening. In yet another non-exclusive embodiment thereof, the present disclosure provides an orthodontic bracket for an orthodontic system comprising a rear base for being mounted to a tooth and first and second portions extending from this rear base and being spaced apart thereby providing a slot therebetween. The slot provides for positioning an arch wire therein. The spaced apart portions define a front opening for receiving the arch wire into the slot.

Generally stated, in a non-exclusive embodiment thereof, the present disclosure provides for an orthodontic bracket including a plurality of brackets having a bracket adjoining mechanism mounted thereto. The bracket adjoining mechanism includes a plurality of inter-bracket adjoining assemblies positioned between a pair of adjacent brackets. An inter-bracket adjoining assembly comprises a pair of intertwined coils. The coils include respective free ends as well as opposite ends having mounting elements; the mounting element of one coil is mounted to one bracket while the mounting element of the other coil is mounted to the other adjacent element. One mounting element is mobile while the other mounting element is fixed. Turning the mobile mounting element causes the coil mounted thereto to turn thereby moving into or outward relative to the other coil as such pulling the adjacent brackets towards each other or pushing them away from each other. In another embodiment, the inter-bracket adjoining assembly includes a single flexible and resilient member secured to adjacent brackets and interposed therebetween that is when acted upon is compressed or extended thereby applying a torsion force which correspondingly modifies the inter-bracket distance.

Generally stated, in a non-exclusive embodiment thereof, the present disclosure provides for an orthodontic bracket system with a front opening leading to a slot for receiving an indented portion therein or an arch wire comprising alternating outward and intended portion. The outward portion following the dental arcade when mounted to the teeth.

With reference to the appended drawings, illustrative embodiments of the present disclosure will be described herein so as to exemplify the disclosure and in no way limit the scope thereof.

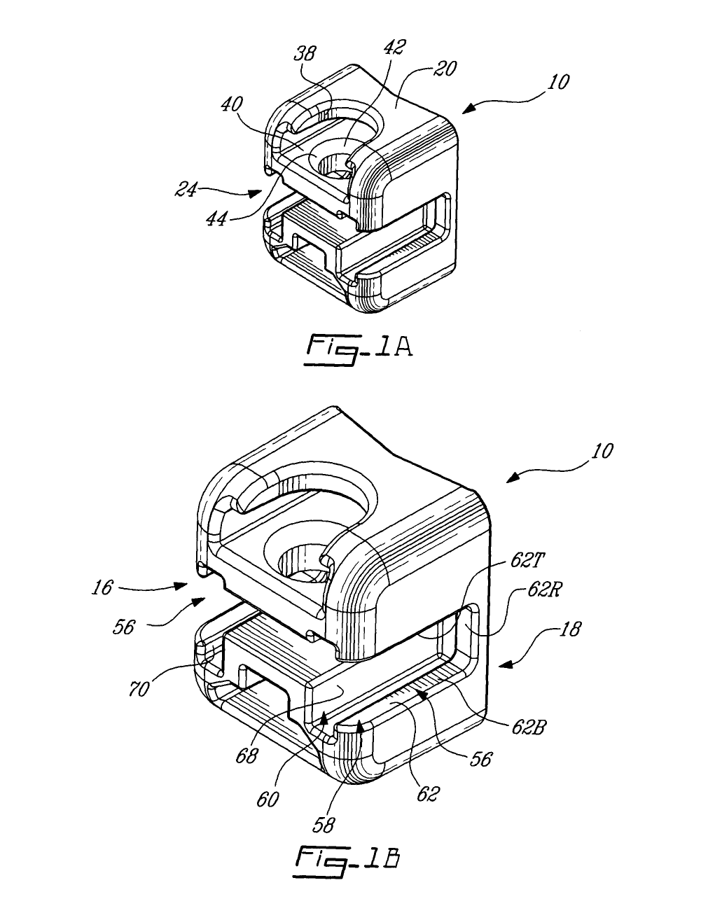

FIGS. 1 to 4 show a bracket 10 including a rear base 11 defining a rear face 12, first and second portion 13 and 15, respectively, forwardly extending from the rear base 11 defining together define a front face 14 and lateral sides 16 and 18 defined by walls. It should be noted that the expression “first” and “second” are only used for indicative purposes and as such as interchangeable. In this example, the first and second portion 13 and 15 are top and bottom portions, nevertheless in the example shown in FIGS. 10-17A, the second portion 15 is the top portion and the first portion 13 is the bottom portion. The foregoing is determined by the vertical position of the bracket 10. When mounted to the teeth of the upper jaw, the bracket 10 will usually be positioned with the first portion being in the downward direction as shown in FIGS. 10-17A and when mounted to the teeth of the lower jaw, the first portion 13 will be the top portion. The foregoing positioning is convenient as the orthodontic practitioner will have better access to the adjustable tightening element which will be described herein. Therefore, the terms “top” and “bottom” as used herein in relation to the bracket 10 and the parts thereof only for indicative purposes to facilitate description only and since there are two optional vertical positions the terms “top” and “bottom” are interchangeable in relation to the bracket 10.

The first portion 13 defines an end surface, in this example being a top surface 20 and the second portion 15 defines an opposite end surface, in this example being a bottom surface 22. The first and second portions 13 and 15 are spaced apart thereby defining a slot 24 therebetween. The rear base 11 and the first and second portions 13 and 15 define an inner surface 23.

The rear base 11 is configured to be secured to the face of a tooth T via adhesive material S between the tooth T and the rear face 12 (see FIGS. 10, 11, 13 and 17).

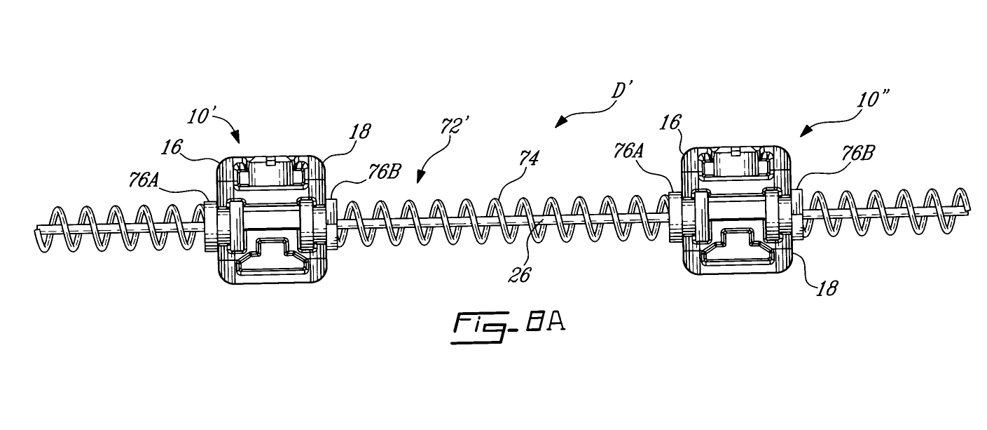

The front face 14 of the bracket includes a front opening 25 leading to slot 24. The slot 24 is configured to position an arch wire 26 therein (see FIGS. 8, 8A, 10 and 11) and to receive this arch wire 26 via the front opening 25.

More specifically, the slot 24 has a front slot portion 24A and a rear slot portion 24B; the rear slot portion 24B forms a tunnel. The front slot portion 24A is defined by top and bottom walls 28 and 30, respectively. The rear slot portion 24B is defined by the top wall 28 as well as a bottom wall 32 which is recessed with respect to bottom wall 30, forming a slanted shoulder 34 therebetween and finally, the slot or tunnel 24B is defined by a back wall 36.

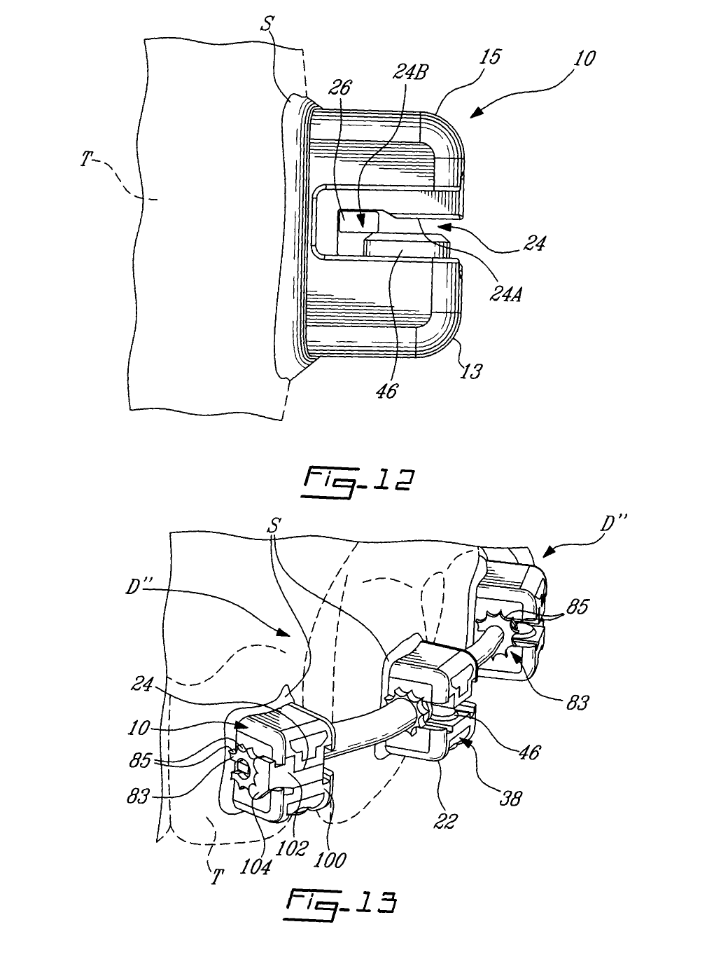

The arch wire 26 can be maintained in the rear portion 24B as shown in FIGS. 12, 14-16 for example or in the front portion 24A as shown in FIGS. 10 and 11.

The top surface 20 of a bracket 10 includes a top opening 38 that leads to a top floor 40 including a hole 42. Hole 42 is circumscribed by a treaded wall 44 and leads into slot 24. The opening 38 as well as the hole 42 provide for an adjustable tightening element such as receiving a set screw 46 (see FIG. 5). FIG. 5A shows that the set screw 46 includes a head 48 as well as a threaded body 50 depending therefrom. The threaded body 50 mutually mates with the threaded wall 44. The underside or shoulder 52 of the screw head 48 abuts the top floor 40. The set screw head 48 includes top engaging elements 54 which allow the orthodontic practitioner to move the body 50 into or out of the hole 42. The bottom end 55 of the threaded body 50 protrudes from the hole 42 into the slot 24 in order to engage the arch wire 26. In this way the set screw 46 is a tightening element which functions to add a tightening force or tension against the wire 26.

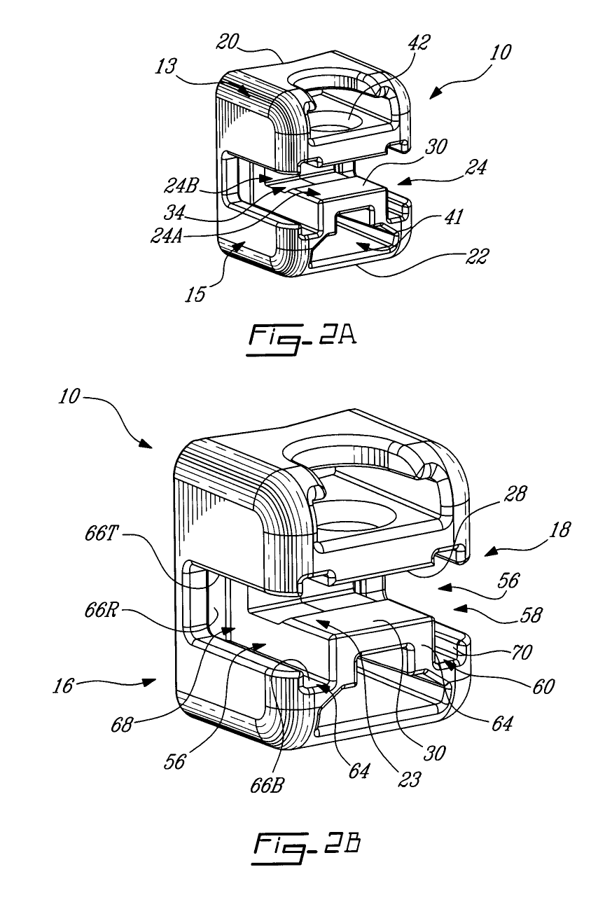

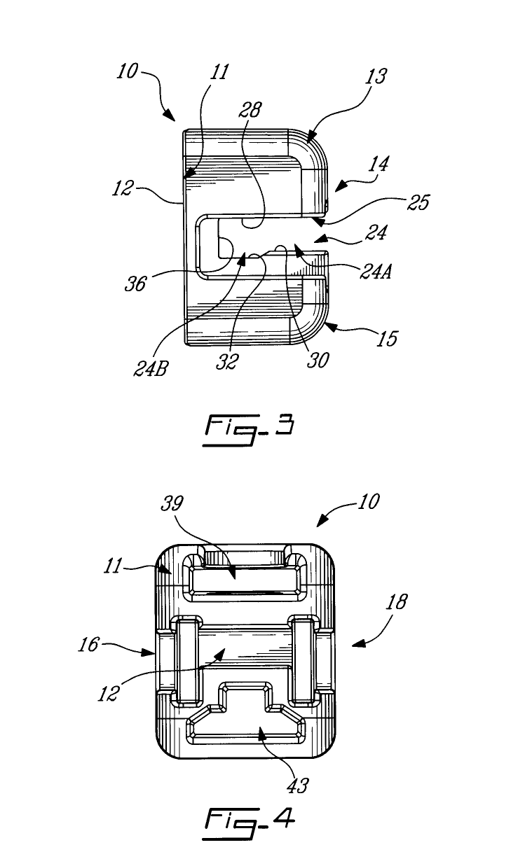

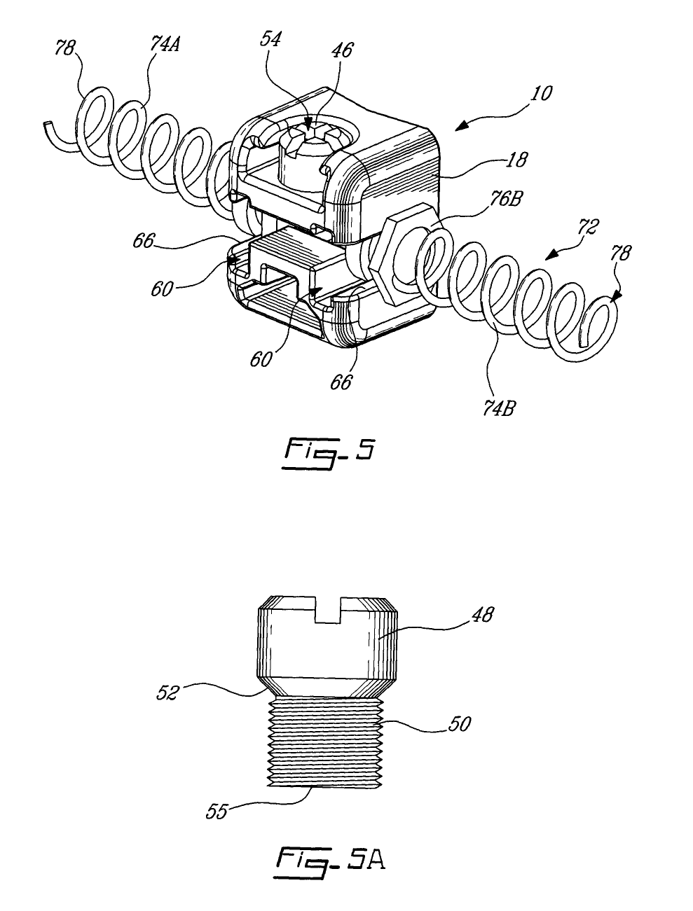

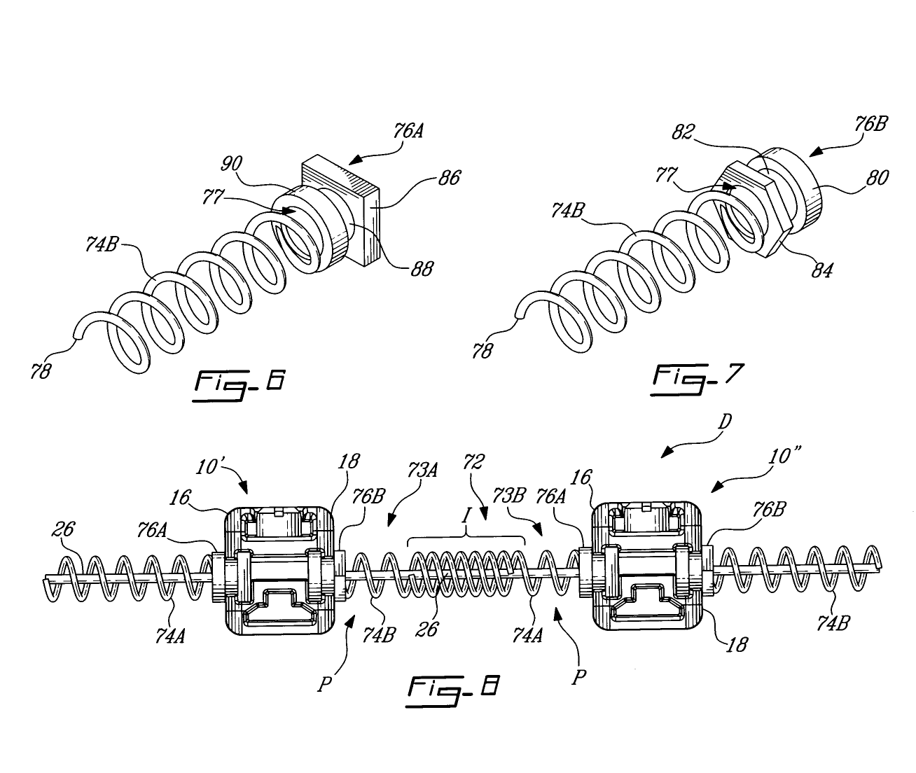

The top opening 38 of the top portion 13 is contiguous with a top rear opening formed 39 (FIG. 4) in the rear base 11. Furthermore, the bottom portion 15 includes a bottom portion opening 41 (FIG. 2A) that is contiguous with a bottom rear opening formed 43 (FIG. 4) in the rear base 11 opening. In this way, the orthodontic practitioner can place the bracket 10 on a tooth T and through openings 38, 39, 41 and 43 and apply an adhesive substance S between the rear face 12 and the tooth T via the front face 14, more particularly by injecting this adhesive substance via the front openings 38 and 41. The foregoing configuration provides for injecting the adhesive substance through the bracket 10, which allows for molding the intrados directly in the mouth without intimate contact of the bracket 10 and the tooth T. The bracket is maintained in the proper position by way of bracket transfer splints and a screw which is released when the adhesive substance has sufficiently polymerized.

With respect to FIGS. 1, 1A, 2, 2A, 3 and 4, the lateral sides 16 and 18 include respective side openings 56 shown, in this example, having c-shaped configurations which are mirror images of each other. The openings 56 provide for the arch wire 26 to extend therethrough. Each opening 56 includes an outer portion 58 adjacent an inner slot 60 formed within the inner surface 23 of the bracket 10. The outer portions 58 defines a c-shaped wall 62 having a top portion 62T a bottom portion 62B and a rear wall portion 62R. The inner slot 60 defines a c-shapes wall 66 that recessed relative to c-shaped wall 62. The bottom walls 30, 32, the back wall 36 and the top wall 28 define an internal c-shaped structure 64. A wall 68 is defined between the recessed wall 66 and the c-shaped structure 64. A wall 70 is defined between the c-shaped walls 62 and 66.

The inner slot 60 is delimited by spaced apart adjacent c-shaped side walls 68 and 70.

The openings 56 provide for mounting the bracket 10 to inter-bracket adjoining assemblies 72.

With reference to FIG. 8 there is shown an orthodontic bracket system D comprising an inter-bracket adjoining assembly 72 comprises a pair of inter-bracket adjoining elements 73A and 73B mounted respective at each side of bracket 10. More particularly, adjoining elements 73A and 73B (which define the assembly 72) of adjacent brackets 10′ and 10″ comprise respective coils, in this example spring coils 74A and 74B, which are intertwined. Each spring coil 74A and 74B includes a respective mounting element 76A and 76B (see FIGS. 7 and 6) at one end thereof and a free opposite end 78. The mounting elements 76A and 76B include openings 77 for the arch wire 26. As will be described below, mounting element 76A is an immobile element mounting element 76B is a mobile element.

With reference to FIG. 7, mounting element 76B includes three portions, namely inner portions 80, median portion 82 and external portion 84. Inner portion 80 has a circular element that is rotatably inserted within the inner c-shaped slot portion 60. Median portion 82 also has a circular configuration and rotatably engages inner c-shaped wall 66. External portion 84 has a hexagonal configuration that abuts the side wall 18 with the coil 74B mounted thereto.

The orthodontist can engage the external portion 84 for rotation of the coil 74A or 74B. As shown in the embodiment of FIG. 13 (which will be discussed below), the external portion 84′ may include engaging elements 85 (in the form of spokes) which allow the orthodontist to have better control of the degree of rotation.

With reference to FIG. 6, the mounting element 76A includes an inner portion 86 having a rectangular configuration for being inserted in slot 60, a median circular portion 88 for engaging wall 66 and an outer circular portion 90 abutting side wall 16 and having the coil 74A mounted thereto. Given the rectangular configuration of the inner portion 86, the mounting element 76A is immobile and the coil 74A is not rotatable.

The arch wire 26 is fitted through the coils 74A and 74B as well as the openings 77 of the mounting element 76A and 76B.

Turning to FIG. 8, the coil 78B can be turned in order to move inwardly into the coil 78A or outwardly therefrom. In this way, the distance between the brackets 10′ and 10′ can be determined in a much more controlled matter. The bracket 10 includes one lateral side 16 having a fixed coil 74A and another lateral side 18 having a mobile or rotatable coil 74B. When the brackets 10 are mounted to the teeth T of a patient, the adjacent coils of adjacent brackets are intertwined. More specifically, the mobile coil 74B of a bracket 10′ and the immobile coil 74A of an adjacent bracket 10″ are intertwined thereby defining the inter-bracket adjoining assembly 72.

The coils 74A and 74B are intertwined about the central arch wire 26 and thus provide for modifying the distance between two adjacent brackets 10. If the orthodontist wishes to increase this distance, the coils (74A, 74B) are compressed between the teeth T and the brackets 10. The orthodontist will thus turn the coils (74A, 74B) in the appropriate direction and hence, the intertwined portion “I” (see FIG. 8) between the two coils is decreased. If on the other hand, the orthodontist wishes to increase the distance between the brackets 10 (and consequently between a pair of adjacent teeth T) the passive length “P” (see FIG. 8) or non-intertwined portion of the adjacent coils 74A and 74B must be shorter thus increasing the intertwined portion “I”, hence this will increase the tension between the two coils 74A and 74B. The length of the coils 74A and 74B will be cut by the orthodontist during the orthodontic procedure according to the patient's needs.

For example, a distance of 10 mm between two brackets 10 can be managed by two coils of 7 mm each with a common intertwined portion “I” of 4 mm. If the orthodontist wishes to increase the inter-bracket distance, the intertwined portion can be reduced to 2 mm, as such the coils will be turned so as to untwine 2 mm, and allow 6 mm of passive or non-intertwined portions “P” at each side of the portion “I” for a total of 12 mm of passive length between two adjacent brackets 10. The inter-bracket distance can also be decreased thus bringing adjacent teeth T closer together by increasing the intertwined portion to 6 mm by way of twining the coils into each other as previously explained.

The flexibility of the coils 74A and 74B between a pair of brackets 10 allows them to follow the dental arcade of the teeth T they are resting on (see FIGS. 10 and 11) all the while allowing the arch wire 26 within the coils 74A and 74B and the brackets 10 to align the teeth T.

Turning now to FIG. 8A, there is shown an orthodontic bracket system D′ comprising an inter-bracket adjoining assembly 72′ which includes a flexible and resilient member provided in the form of a single coil 74 connected at one end thereof to a mounting element 76A which mounted to one bracket 10″ and at the opposite end thereof to a mounting element 76B which is mounted to an adjacent bracket 10′. In this embodiment, the inter-bracket distance is acted upon not by varying or modifying the distance of the inter-bracket adjoining assembly but by the torsion of the coil 74. The movable mounting element 76B can be turned to increase the torsion force of the coil 74 thereby bringing two teeth T closer. More specifically, the coil 74 can be compressed thereby pushing against the two adjacent brackets 10′ and 10″ and consequently increasing the inter-bracket distance, or extended thereby pulling the two adjacent brackets 10′ and 10″ thereby decreasing the inter-bracket distance.

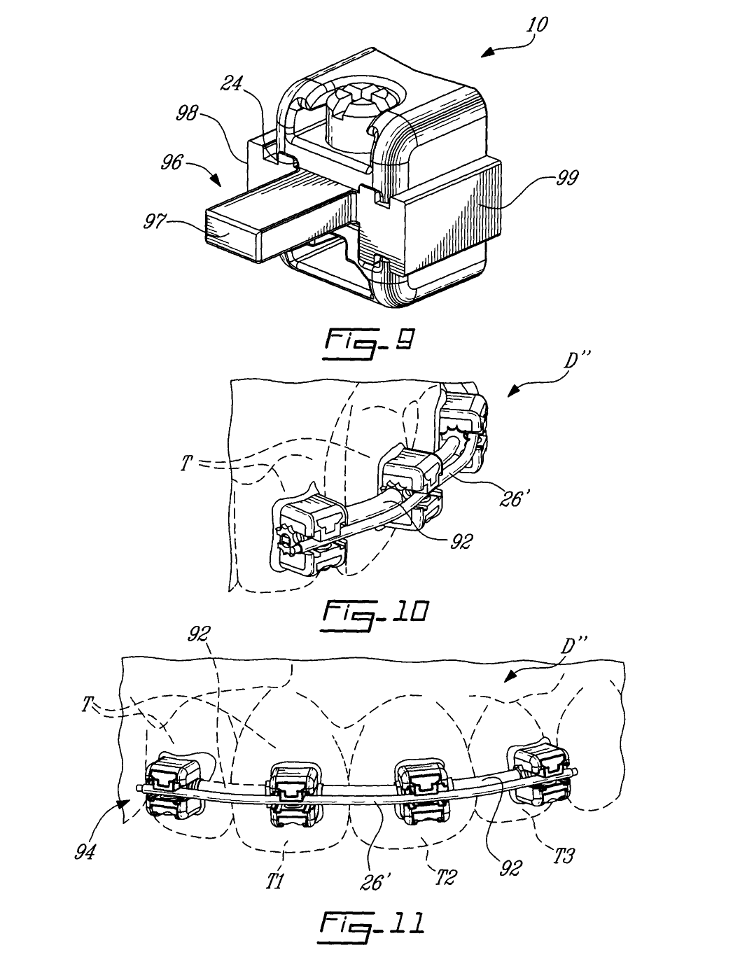

With respect to FIG. 9, a bracket 10 can be isolated by including an insert 96 within the slot 24 that is flanked by locking elements 98 and 99 and an extension 97 (in another embodiment the extension is removed); as such a bracket 10 can be isolated. Insert 96 provides for keeping the slot 24 free of adhesive substance when adhering or anchoring the bracket 10 onto a tooth T.

Turning to FIGS. 10 to 13 there is shown an orthodontic bracket system D″ comprising a plurality of brackets 10 mounted to teeth T via an adhesive substance S, certain adjacent brackets are adjoined together by inter-bracket adjoining assemblies 92. It should be noted that the orthodontic systems of the present disclosure do not require that every pair of adjacent brackets 10 be adjoined via the adjoining assemblies disclosed herein. The orthodontic practitioner will decide which pairs need adjoining based on the selected treatment.

The inter-bracket adjoining assembly 92 can be made of a pair of intertwined coils, a flexible and resilient member such as a single coil or a tubular structure provided the foregoing can increase or decrease the distance and tension between a pair of adjacent brackets 10 and consequently the teeth to which these brackets are mounted to.

Since the brackets 10 are mounted to the teeth of the top jaw the surface 20 with the opening 38 which provides access to the set screw is downwardly positioned making it more convenient for the orthodontic practitioner to adjust the set screw 46 and as such, the first portion 13 is a bottom portion and the second portion 15 is a top portion.

FIGS. 10-13 show various possible scenarios of setting up the present system to a patient.

In FIGS. 10 and 11, the arch wire 26′ is positioned in front of the inter-bracket adjoining assembly 92 and as such in the front slot portion 24A. Alternatively, the adjoining assemblies 92 may also include an arch wire therethrough (see 26 in stippled line in FIG. 11) and as such the arch wire 26′ is an additional wire. Finally, as can be contemplated by FIGS. 12 and 13, there is only one arch wire 26 mounted in the rear slot portion 124B and through the adjoining assemblies 92.

A locking mechanism 100, shown in FIG. 13, can also be inserted in the slot 24. The locking mechanism 100 includes an insert 102 positioned within the slot 24 as well as stoppers 104 at each side thereof that engage the spokes 85 thereby immobilizing the mounting element 83 from rotating.

The disclosed system facilitates anchorage of the brackets 10 allowing for a more controlled distribution of the tension force on the teeth while providing for the ability to decrease the tension force caused by anchorage thus avoiding displacement of teeth that do not need to be corrected. For example, in FIG. 10, teeth T1, T2 and T3, respectively need a minor correction, no correction and moderate correction, the present system provides for achieving such results with great efficiency.

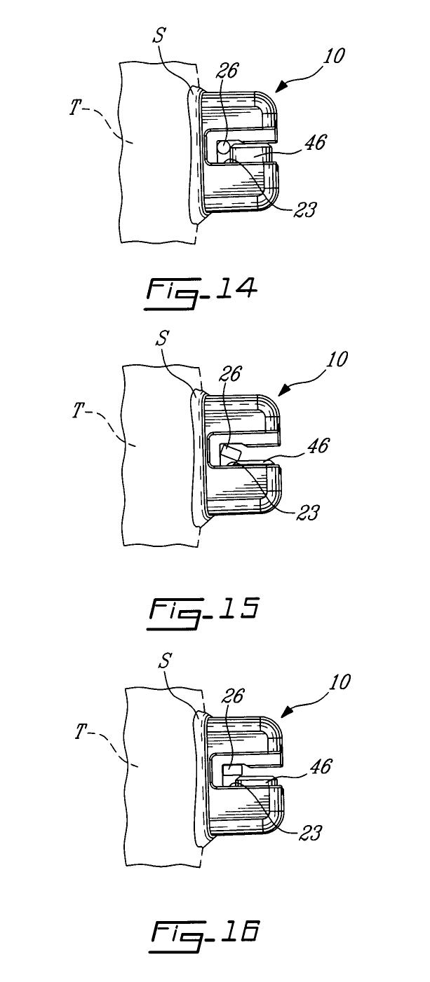

The foregoing can better be illustrated with reference to FIGS. 12 and 14 to 16. FIGS. 12 and 16 and show an anchored bracket 10, which means that the set screw 46 is moved inwardly to add enough tension against the rectangularly shaped wire 26 which sandwiches and thereby fastesn the wire 26 against the inner surface 23 of the bracket 10. Thus rigidly locking the bracket 10 and the wire 26 together. FIG. 14 shows a similar setting to FIGS. 12 and 16, yet in this case the wire 26 is tubular, such wires are used at the beginning of orthodontic treatment to provide alignment. FIG. 15 on the other hand shows a non-anchored wire 26 which is obliquely positioned but is not rigidly fastened within the bracket 10, thereby it can easily transversely slide along the inner surface 23 of the bracket 10.

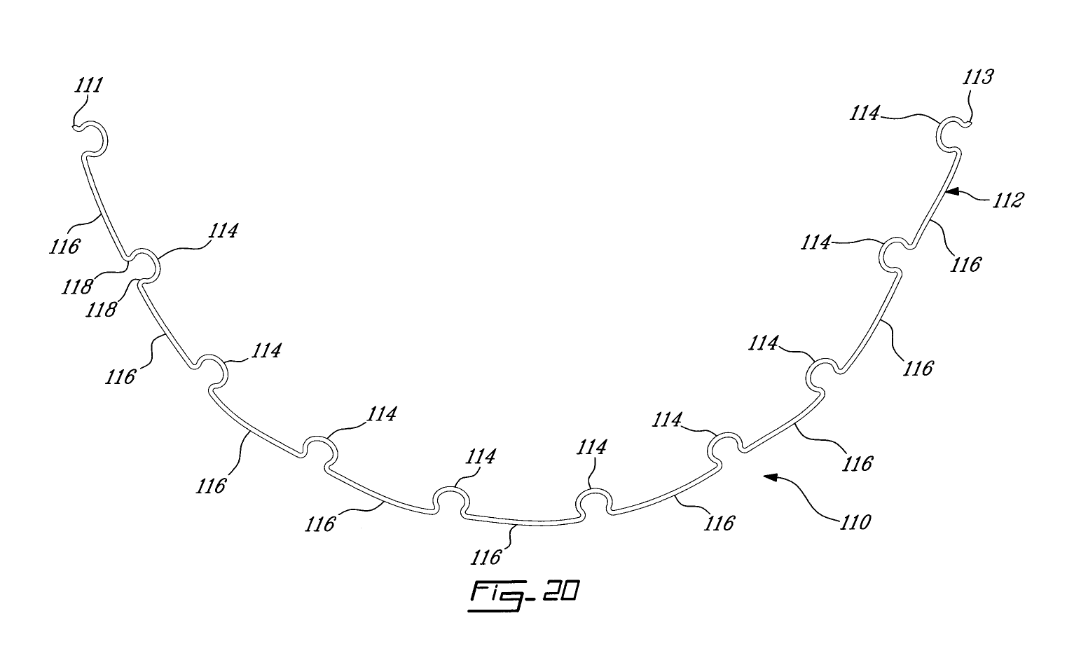

Turning now to FIGS. 16-22, there is shown an orthodontic bracket system D′″ comprising a plurality of brackets 10 mounted to teeth T of the upper jaw J as well as an arch wire 110 mounted to the brackets 10.

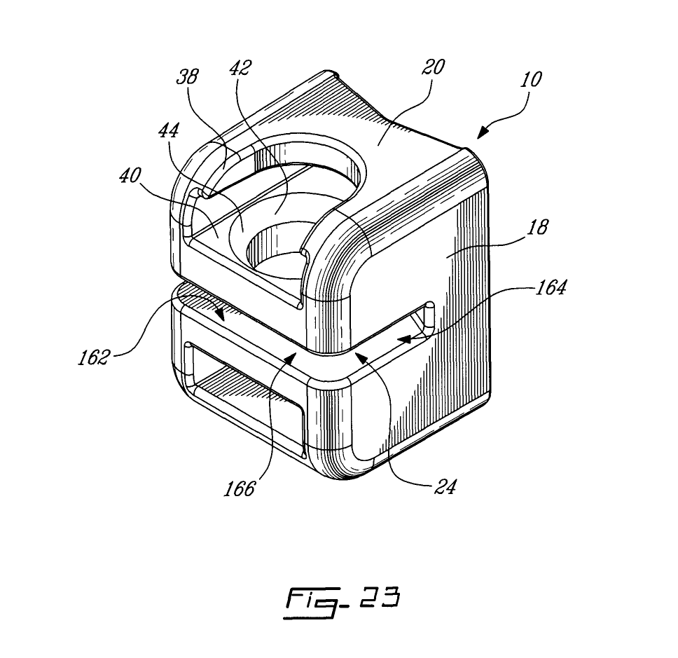

The arch wire 110 shown in FIG. 22 includes a main body 112 having opposite free ends 111 and 113 with a plurality of spaced apart indentations 114 in the form inwardly curved notches thereby providing alternating outward portions 116 and indented portion 114. The outward portions 116 are curved so as to follow the dental arcade of the teeth T they are resting on, as is well known in the art. The indented portions 114 are fitted into the brackets 10, within the slot 24, via their front face openings 25. The configuration of the wire 110 can provide that the wire 110 does not need to extend through the openings 56 of the lateral sides 16 and 18 of the bracket 10. In fact, the elbows or joints 118 formed between the wire portions 114 and 116 may extend only through the front face opening 25 to provide for indented portion 114 to be inserted within the slot. Alternatively, the elbows 118 and directly adjacent areas of the outward portion 116 may in fact cross through the openings 56 as shown in this example.

In one embodiment, the arch wire 110 is a shape-memory wire.

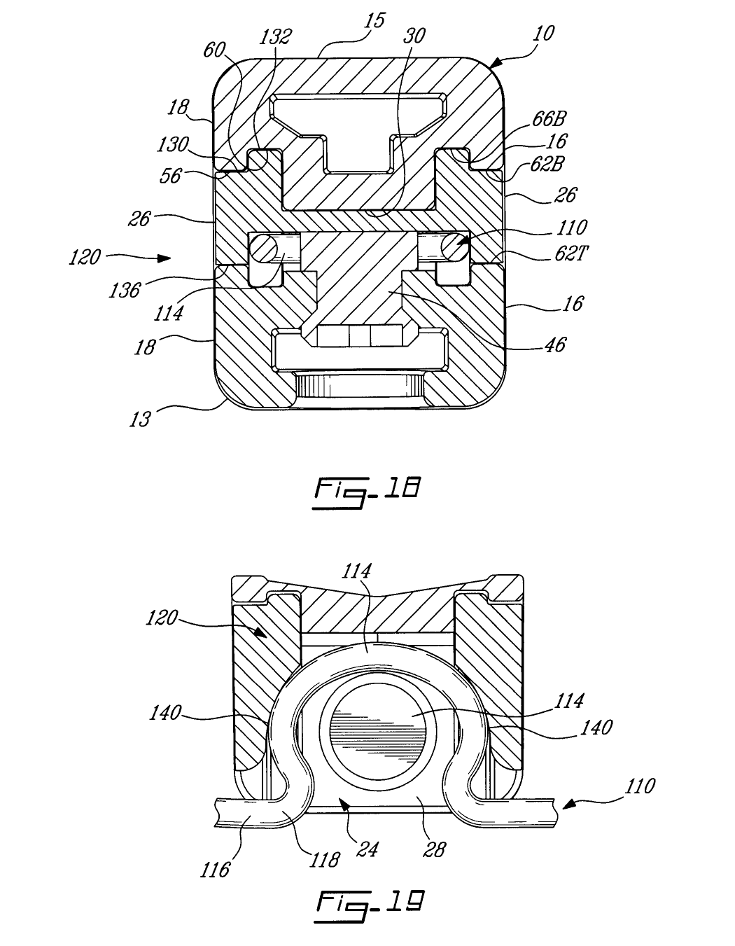

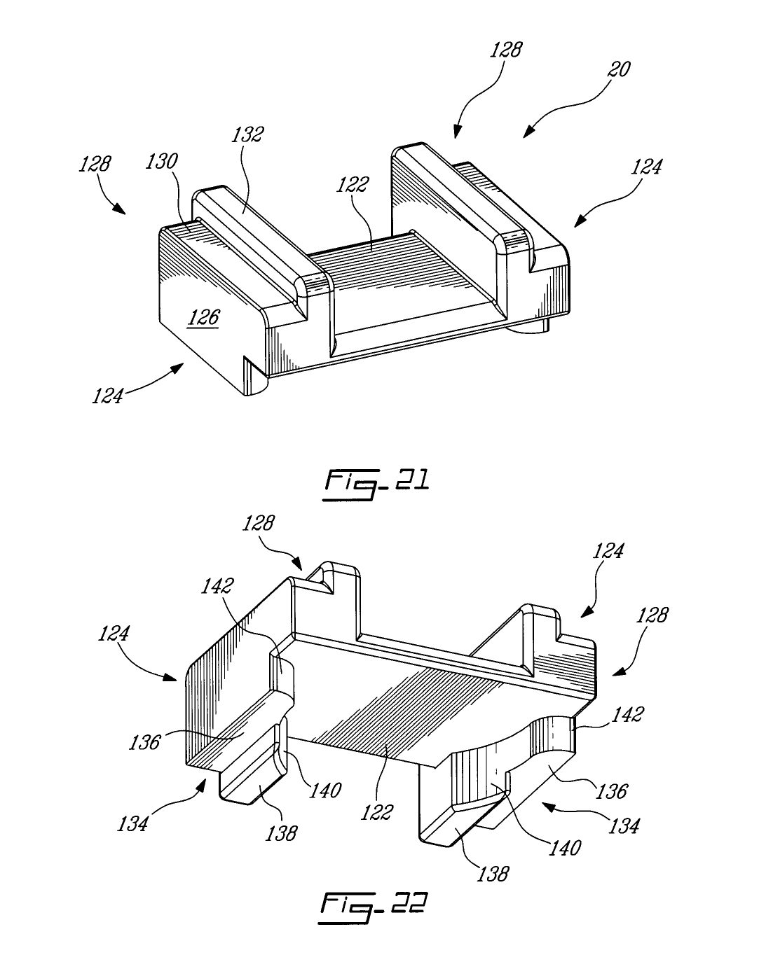

The width of the lateral side openings 56 of each bracket can be decreased by way of a bracket insert 120 better shown in FIGS. 21 and 22 which is mounted to the bracket via the slot 24 and openings 25 and 56 as shown in FIG. 18.

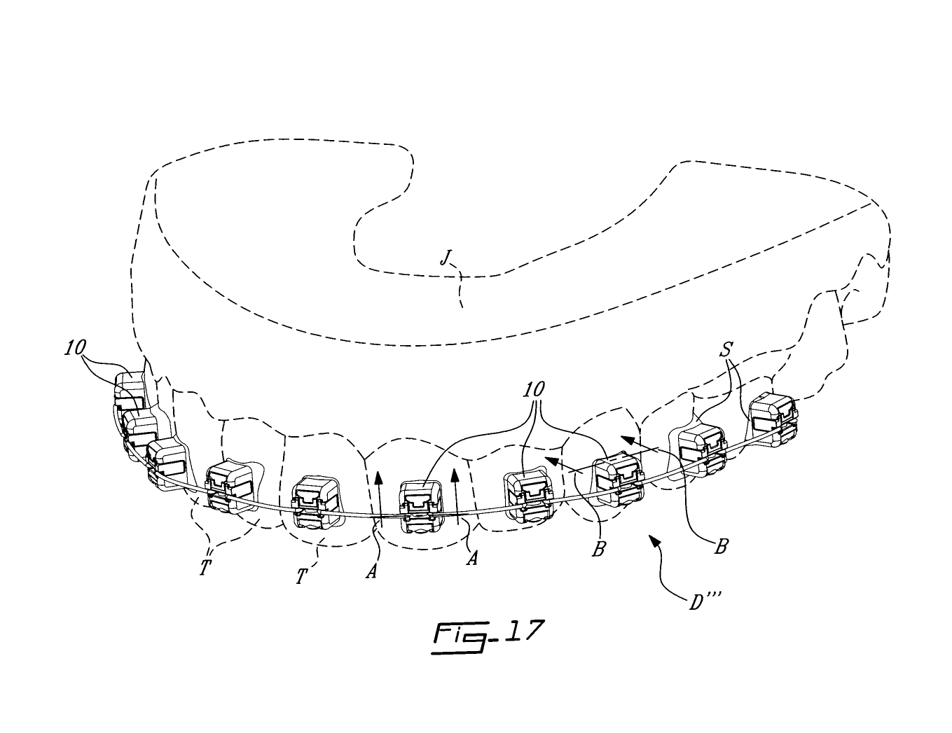

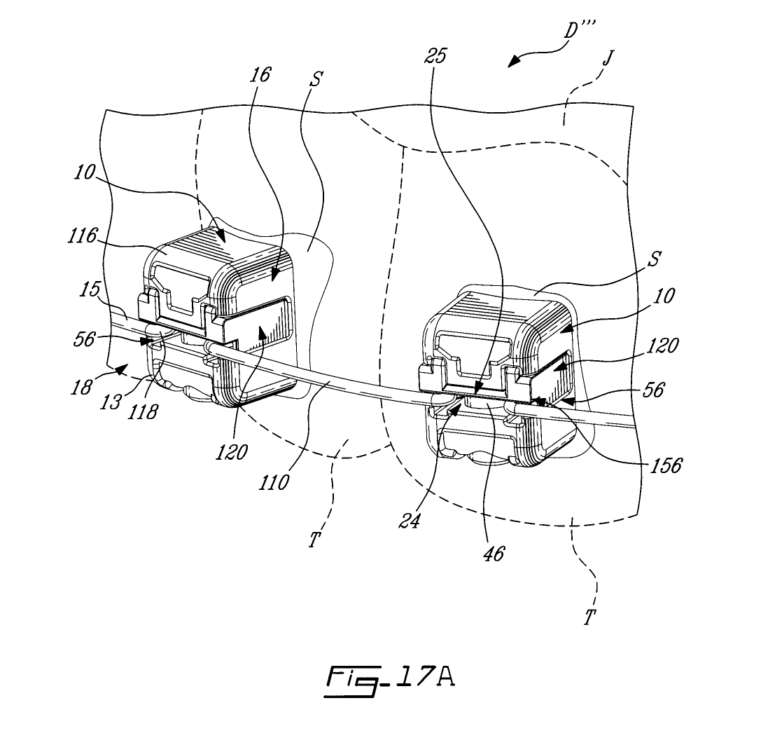

More particularly and with reference to FIGS. 18, 19, 21, and 22, the insert 120 includes a main platform 122 that is inserted within the slot 24 and sandwiched between the bracket inner wall 30 and the set screw 46. It should be noted that the insert 120 can be held in place without the use of the set screw 46. The platform is flanked by lateral wings 124 having lateral walls 126 which when inserted within the brackets 10 are contiguous with walls 16 or 18. The lateral wings 125 include first fin structures 128 having offset outer and inner walls 130 and 132 which respectively mate with the bracket inner walls 62B and 66B defined by the slot 60. The lateral wings 124 also include second fin structures 134 which have offset outer and inner walls 136 and 138 which respectively mate with the bracket inner walls 62T and 66T defined by the slot 60. Furthermore, the inner peripheral walls 140 of each second fin structure 134 are recessed so as to provide a space for the inward notch 114 of the arch wire 110. The front ends 142 of the second fin structures 134 are inwardly recessed thereby providing clearance or opening 156 for the arch wire 110 that is substantially smaller than opening 56 (see FIG. 17A). The foregoing structure provides for decreasing the width of the lateral side openings 56.

The notch or indented portion 114 circumscribes the set screw 46. Portion 46 can be maintained within the bracket 10 via the set screw or ligatures as is known in the art.

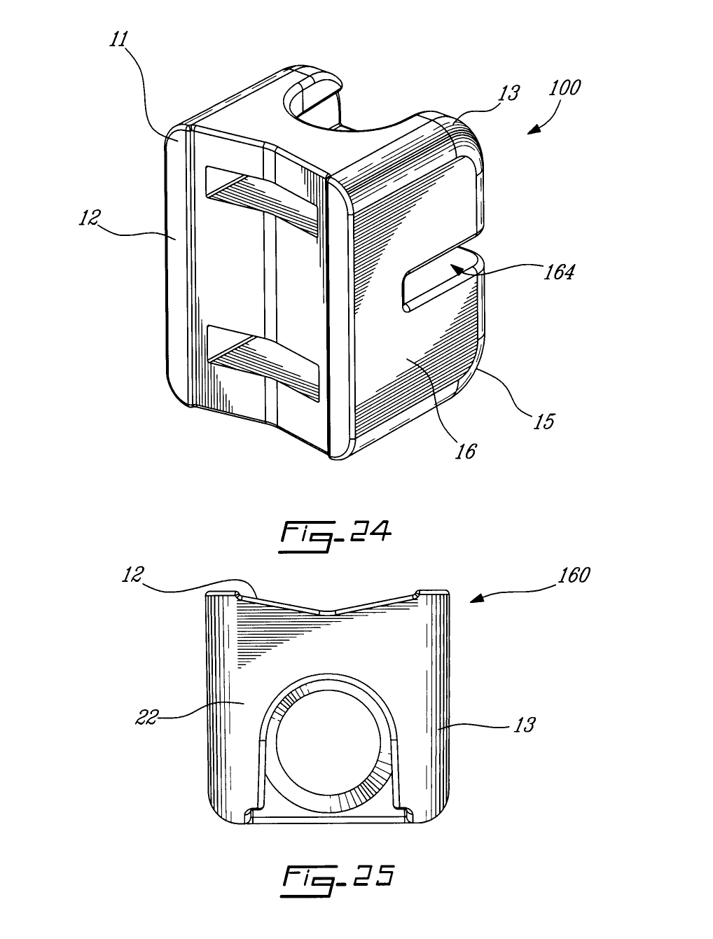

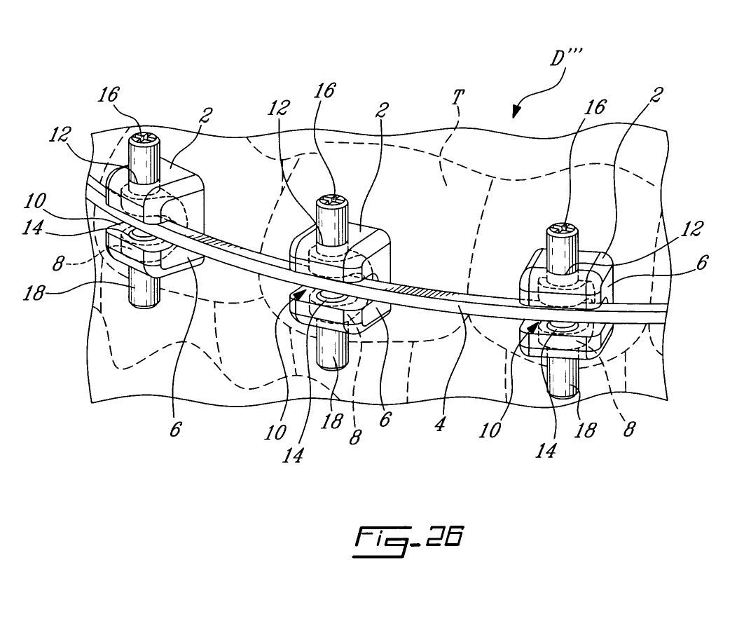

FIGS. 23, 24 and 25 show a bracket 160 that is similarly constructed to bracket 10 and as such only the differences will be highlighted for concision purposes only. In this case the front opening 162 is smaller than the front opening 25 and is configuratively contiguous with the lateral side openings 164 of the sides 18 and 16 thereby providing a common slit 166 which leads to the inner slot 24.

FIG. 26 shows another embodiment of an orthodontic bracket system D″″ comprising a plurality of orthodontic brackets 202 mounted to teeth T as well as an arch wire 204 mounted to the brackets 202. Each bracket 202 includes an outer shell member 206 with a C-shaped member 208 mounted therein and forming the opening 210 for receiving the arch wire 204. Each bracket 202 includes top and bottom holes 212 and 214 respectively for top and bottom set screws 216 and 218 respectively for gripping and releasing the arch wire 204 therebetween.

### Process of Manufacture

The various brackets disclosed herein can be injection molded with various biocompatible materials including metal, plastic resin as well as other suitable materials known in the art. Of course, the brackets can also be produced by partial or complete machining. A pair of brackets can be made out of metal; more particularly the centre or core can be metallic including the set screw with the rest of the body being formed or molded with plastic, resin and assembled onto the core. The brackets can be mounted on dental prefabricated laboratory models at the intrados can be a composite of these models, which can then be adhered to teeth within the mouth of the patient while using conventional processes.

Methodology of using the orthodontic systems.

The systems disclosed herein can be installed directly on the teeth of the patient by conventional methods, such as direct bonding or indirectly by using models (i.e. with a set up of uncorrected teeth) and then transferred to the mouth. Another method, which is more precise, is to use numeric positioning via virtual model. (cad cam) and then to transfer the positioned brackets to the mouth via bracket transfer splints by cad or traditional methods.

The brackets and systems disclosed herein can be used with conventional arch wires and conventional treatment techniques can also be used The treatment approach can be buccal or lingual or any combination thereof including Invisalign™

The system includes a plurality of advantages, such as using na more precise wire that provides faster and more comfortable treatment all the while avoiding friction with greater inter bracket angulatio. The shape memory wire provides better alignment control and is more efficient all the while applying low biomechanical as it more accurately positioned on the dental arcade.

The various features described hereinabove can be combined in a variety of suitable ways, as the skilled artisan will readily appreciate, so as to provide further embodiments within the scope of the present disclosure. Furthermore, it is to be understood that the disclosure is not limited in its application to the details of construction and parts illustrated in the accompanying drawings and described hereinabove. The disclosure is capable of other embodiments and of being practiced in various ways. It is also to be understood that the phraseology or terminology used herein is for the purpose of description and not limitation. Hence, although the present disclosure has been described hereinabove by way of embodiments thereof, it can be modified, without departing from the spirit, scope and nature of the subject disclosure.

What is claimed is:

1. An orthodontic bracket for an orthodontic system comprising:
a rear base for being mounted to a tooth; and
first and second portions extending from said rear base and being spaced apart thereby providing a slot therebetween for positioning an arch wire therein and defining a front opening for receiving the arch wire into said slot, at least one of said first and second portions comprising an adjustable tightening element for engaging the arch wire,
wherein adjustment of said tightening element provides for increasing or decreasing tension against the arch wire within said slot.

2. An orthodontic bracket according to claim 1, wherein said first and second portions define a front face, said front face comprising said front opening.

3. An orthodontic bracket according to any one of claim 1 or 2, further comprising lateral sides.

4. An orthodontic bracket according to claim 3, wherein said lateral sides provide for mounting an inter-bracket adjoining assembly to said orthodontic bracket.

5. An orthodontic bracket according to any one of claim 3, wherein said lateral sides comprise respective side openings leading to said slot thereby providing the arch wire to extend outwardly from said side openings when positioned in said slot.

6. An orthodontic bracket according to any one of claims 3 to 5, wherein said first and second portions and said rear base define a bracket inner surface, said bracket inner surface comprising an inner slot near each said lateral side.

7. An orthodontic bracket according to claim 6, wherein said inner surface comprises a c-shaped wall and wherein each inner slot runs along said c-shaped wall.

8. An orthodontic bracket according to any one of claim 6 or 7, wherein said inner slots provide for mounting a inter-bracket adjoining assembly to said orthodontic bracket.

9. An orthodontic bracket according to any one of claims 6 to 8, wherein said inner slots provide for receiving an insert.

10. An orthodontic bracket according to claim 9, wherein said insert provides for modifying the size of said side openings.

11. An orthodontic bracket according to any one of claims 1 to 10, wherein said slot provides for receiving an insert therein.

12. An orthodontic bracket according to any one of claims 1 to 11, wherein at least one said first and second portion comprises a front opening, said rear base comprising a rear opening being contiguous with said front opening thereby providing for applying an adhesive substance between said rear base and the tooth via said front opening.

13. An orthodontic bracket according to any one of claims 1 to 12, wherein said rear base comprises a rear face, said rear face being inwardly recessed.

14. An orthodontic bracket according to any one of claims 1 to 13, wherein said adjustable tightening element comprises a set screw.

15. An orthodontic bracket according to claim 14, wherein one of said first and second portion comprises a hole leading into said slot for receiving said set screw.

16. An orthodontic bracket according to any one of claims 1 to 15, wherein each said first and second portion comprise respective end surfaces surface, wherein said adjustable tightening element protrudes from one of said end surfaces for adjustable control thereof.

17. An orthodontic bracket according to any one of claims 1 to 16, wherein both said first and second portions thereof comprise an adjustable tightening element for engaging the arch wire.

18. An orthodontic bracket according to any one of claims 1 to 17, wherein said first portion comprises a top portion and said second portion comprises a bottom portion.

19. An orthodontic bracket according to any one of claims 1 to 17, wherein said first portion comprises a bottom portion and said second portion comprises a top portion.

20. An orthodontic bracket according to any one of claim 18 or 19, wherein said top portion comprises a top portion opening, said rear base comprising a top rear opening being contiguous with said top portion opening thereby providing for applying an adhesive substance between said rear base and the tooth via said top portion opening.

21. An orthodontic bracket according to any one of claim 18 or 19, wherein said bottom portion comprises a bottom portion opening, said rear base comprising a bottom rear opening being contiguous with said bottom portion opening thereby providing for applying an adhesive substance between said rear base and the tooth via said bottom portion opening.

22. An orthodontic bracket for an orthodontic system comprising:
a rear base defining a rear face for being mounted to a tooth; and
first and second portions extending from said rear base and providing a slot therebetween for positioning an arch wire therein and defining a front face having at least one opening being contiguous with a rear opening formed in said rear face,
wherein injecting an adhesive substance within said one opening provides for applying the adhesive substance between said rear base and the tooth via said rear opening.

23. An orthodontic bracket according to claim 22, wherein said first and second portions are spaced apart thereby providing said slot therebetween.

24. An orthodontic bracket according to any one of claim 22 or 23, wherein said front face further comprises a front opening for receiving the arch wire into said slot.

25. An orthodontic bracket according to any one of claims 22 to 24, wherein at least one of said first and second portions comprises an adjustable tightening element for engaging the arch wire in said slot.

26. An orthodontic bracket according to any one of claims 23 to 25, further comprising lateral sides, each said lateral side comprising a respective side openings leading to said slot thereby providing the arch wire to extend outwardly from said side openings when positioned in said slot.

27. An orthodontic bracket according to claim 25, wherein said lateral sides provide for mounting an inter-bracket adjoining assembly to said orthodontic bracket.

28. An orthodontic bracket according to any one of claim 26 or 27, wherein said lateral sides provide for receiving an insert.

29. An orthodontic bracket according to claim 28, wherein said insert provides for modifying the size of said side openings.

30. An orthodontic bracket according to any one of claims 23 to 29, wherein said slot provide for receiving an insert.

31. An orthodontic bracket according to any one of claims 22 to 30, wherein said rear base comprises a rear face, said rear face being inwardly recessed.

32. An orthodontic bracket according to any one of claims 1 to 31, wherein said adjustable tightening element comprises a set screw.

33. An orthodontic bracket according to claim 32, wherein one of said first and second portions comprises a hole leading into said slot for receiving said set screw.

34. An orthodontic bracket according to any one of claims 25 to 33, wherein each said first and second portion comprise respective end surfaces surface, wherein said adjustable tightening element protrudes from one of said end surfaces for adjustable control thereof.

35. An orthodontic bracket according to any one of claims 23 to 34, wherein both said first and second portions thereof comprise an adjustable tightening element for engaging the arch wire.

36. An orthodontic bracket according to any one of claims 22 to 35, wherein said first portion comprises a top portion and said second portion comprises a bottom portion.

37. An orthodontic bracket according to any one of claims 22 to 35, wherein said first portion comprises a bottom portion and said second portion comprises a top portion.

38. An orthodontic bracket according to any one of claim 36 or 38, wherein said top portion comprises said one opening.

39. An orthodontic bracket according to any one of claim 36 or 38, wherein said bottom portion comprises said one opening.

40. An orthodontic bracket for an orthodontic system comprising:
a rear base for being mounted to a tooth; and
first and second portions extending from said rear base and being spaced apart thereby providing a slot therebetween for positioning an arch wire therein and defining a front opening for receiving the arch wire into said slot.

41. An orthodontic bracket according to claim 40, further comprising lateral sides comprising openings being contiguous with said slot thereby providing for the arch wire to extend therethrough.

42. An orthodontic bracket according to claim 41, further comprising an insert mountable to said lateral side opening for decreasing the width thereof.

43. An orthodontic bracket system comprising:
a plurality of brackets for being mounted to the teeth of a patient; and
at least one inter-bracket adjoining assembly mounted to a pair of adjacent said brackets and interposed therebetween;
wherein the length of said inter-bracket adjoining assembly is modifiable so as to correspondingly modify the distance between said pair of adjacent brackets.

44. An orthodontic bracket system according to claim 43, wherein said inter-bracket adjoining assembly comprises a pair of separate adjoining elements.

45. An orthodontic bracket system according to claim 44, wherein each said separate adjoining element comprises a respective mounting element for being mounted to one of said pair of brackets.

46. An orthodontic bracket system according to claim 45, wherein said bracket comprise lateral sides configured to receive a said mounting element.

47. An orthodontic bracket system according to claim 46, wherein said lateral sides comprise respective openings for receiving a said mounting element therein.

48. An orthodontic bracket system according to claim 47, wherein said lateral sides comprise respective slots for receiving a said mounting element therein.

49. An orthodontic bracket system according to any one of claims 45 to 48, wherein one of said mounting elements is movable with respect to said bracket when mounted thereto whereas the other of said mounting elements is immovable with respect to said bracket when mounted thereto.

50. An orthodontic bracket system according to claim 49, wherein movement of said movable mounting member provides for modifying the length of said inter-bracket adjoining assembly.

51. An orthodontic bracket system according to any one of claim 49 or 50, wherein said movable mounting element comprises engaging elements for controlling the movement thereof.

52. An orthodontic bracket system according to claim 51, wherein the movement of said movable mounting element comprises a rotational movement.

53. An orthodontic bracket system according to any one of claims 43 to 52, wherein said inter-bracket adjoining assembly comprises a pair of coils, each said coil being secured to a respective one of said pair of adjacent brackets.

54. An orthodontic bracket system according to claim 53, wherein said coils are intertwined.

55. An orthodontic bracket system according to claim 54, wherein movement of one said coil in a first direction provides for moving said one coil inwardly into the other said coil thereby decreasing the length of said inter-bracket adjoining assembly, wherein movement of said coil in a second direction provides for moving said one coil outwardly of the other said coil thereby increasing the length of said inter-bracket adjoining assembly.

56. An orthodontic bracket system according to claim 55, wherein said movement of said one coil is a rotational movement.

57. An orthodontic bracket system according to any one of claims 43 to 56, further comprising an arch wire mounted to said brackets.

58. An orthodontic bracket system according to claim 57, wherein said arch wire is positioned through said inter-bracket adjoining assembly.

59. An orthodontic bracket system according to any one of claim 57 or 58, wherein said brackets comprise a respective slot and respective open lateral sides, said arch wire being positioned through said slot and said open lateral sides.

60. An orthodontic bracket system according to any one of claims 43 to 59, wherein each said bracket comprises an open front face for receiving an arch wire therein.

61. An orthodontic bracket system according any one of claims 58 to 60, further comprising an additional arch wire.

62. An orthodontic bracket system according to claim 61, wherein said additional arch wire is positioned in front of said inter-bracket adjoining assembly.

63. An orthodontic bracket system according to claim 57, wherein said arch wire is positioned in front of said inter-bracket adjoining assembly.

64. An orthodontic bracket system comprising:
a plurality of brackets for being mounted to the teeth of a patient; and
at least one inter-bracket adjoining assembly comprising a flexible and resilient element and being mounted to a pair of adjacent said brackets and interposed therebetween,
wherein said resilient element is so compressible or extendable as to correspondingly modify the distance between said pair of adjacent brackets.

65. An orthodontic bracket system according to claim 64, wherein said a inter-bracket adjoining assembly comprises a pair of mounting elements at each end of said resilient and flexible element, each said mounting element being mounted to one of said pair of brackets.

66. An orthodontic bracket system according to claim 65, wherein said bracket comprise lateral sides configured to receive a said mounting element.

67. An orthodontic bracket system according to claim 66, wherein said lateral sides comprise respective openings for receiving a said mounting element therein.

68. An orthodontic bracket system according to claim 67, wherein said lateral sides comprise respective slots for receiving a said mounting element therein.

69. An orthodontic bracket system according to any one of claims 65 to 68, wherein one of said mounting elements is movable with respect to said bracket when mounted thereto whereas the other of said mounting elements is immovable with respect to said bracket when mounted thereto.

70. An orthodontic bracket system according to claim 69, wherein movement of said movable mounting member provides for extending or compressing said flexible and resilient member.

71. An orthodontic bracket system according to any one of claim 69 or 70, wherein said movable mounting element comprises engaging elements for controlling the movement thereof.

72. An orthodontic bracket system according to claim 71, wherein the movement of said movable mounting element comprises a rotational movement.

73. An orthodontic bracket system according to any one of claims 43 to 72, wherein said flexible and resilient member comprises a coil being secured to a respective one of said pair of adjacent brackets.

74. An orthodontic bracket system according to claim 73, wherein movement of said coil in a first direction compresses said coil providing a compression and wherein movement of said coil in a second direction provides for extending said coil.

75. An orthodontic bracket system according to claim 74, wherein said movement of said one coil is a rotational movement.

76. An orthodontic bracket system according to any one of claims 64 to 75, further comprising an arch wire mounted to said brackets.

77. An orthodontic bracket system according to claim 75, wherein said arch wire is positioned through said inter-bracket adjoining assembly.

78. An orthodontic bracket system according to any one of claim 76 or 77, wherein said brackets comprise a respective slot and respective open lateral sides, said arch wire being positioned through said slot and said open lateral sides.

79. An orthodontic bracket system according to any one of claims 64 to 78, wherein each said bracket comprises an open front face for receiving an arch wire therein.

80. An orthodontic bracket system according any one of claims 76 to 77, further comprising an additional arch wire.

81. An orthodontic bracket system according to claim 80, wherein said additional arch wire is positioned in front of said inter-bracket adjoining assembly.

82. An orthodontic bracket system according to claim 76, wherein said arch wire is positioned in front of said inter-bracket adjoining assembly.

83. An orthodontic bracket system according to claim 64, wherein said resilient and flexible member comprises a tubular member.

84. An orthodontic bracket system comprising:
a rear base for being mounted to a tooth;
first and second portions extending from said rear base and being spaced apart thereby providing a slot therebetween and defining a front opening leading to said slot; and
an arch wire comprising indented portions thereof for being positioned within said slot via said front opening.

85. An orthodontic bracket system according to claim 84, wherein said arch wire comprises outward portions alternating with said indented portions along the length thereof, said outward portions being provided to follow the dental arcade when mounted to the teeth of the user.

86. An orthodontic bracket system according to any one of claims 84 to 85, wherein said bracket further comprises lateral sides comprising openings for providing said arch wire to extend therefrom.

87. An orthodontic bracket system according to claim 66, further comprising at least one insert for being inserted in a given said bracket thereby decreasing the width of said lateral side opening.

88. An orthodontic kit comprising an orthodontic bracket in accordance with any one of claims 1 to 42.

89. An orthodontic kit comprising an orthodontic system in accordance with any one of claims 43 to 87.

90. A process of making an orthodontic bracket in accordance with any one of claims 1 to 42.

91. A process of making an orthodontic bracket in accordance with any one of claims 43 to 87.

92. A method of treating the dental bite of a human patient by applying to the teeth of the human patient an orthodontic bracket system in accordance with any one of claims 43 to 87.
